(19) United States
(12) Patent Application Publication
(10) Pub. No.: US 2024/0327060 A1
(43) Pub. Date: Oct. 3, 2024

(54) PACKAGE FOR THE CONTAINMENT AND THE DISPLAY OF ARTICLES AND RELATED MANUFACTURING PROCESS

(71) Applicant: E'CLOSE S.R.L., Verona (IT)

(72) Inventors: Elisa BONNINI, Verona (IT); Alessandro GROPPI, Verona (IT)

(73) Assignee: E'CLOSE S.R.L., Verona (IT)

(21) Appl. No.: 18/694,482

(22) PCT Filed: Sep. 26, 2022
(86) PCT No.: PCT/IB2022/059107

§ 371 Date: Mar. 22, 2024

(30) Foreign Application Priority Data
Sep. 24, 2021 (IT) 1020210000245952

(51) Int. Cl. B65D 5/50; B31B 50/62; B31B 105/00; B31B 110/35; B65D 65/46

(52) U.S. Cl. CPC B65D 5/503; B31B 50/622; B65D 5/5059; B65D 65/466; B31B 2105/00; B31B 2110/35

(57) ABSTRACT

A package for containment and display of articles comprises: a box-shaped body provided with a bottom and with side walls adapted to bound a housing compartment; at least one first supporting structure comprising at least one housing cavity for the housing of a respective article; at least one second supporting structure side by side to the first supporting structure and comprising at least one housing cavity for the housing of a further respective article; wherein the supporting structures are configured to be at least partly fitted inside the housing compartment, and wherein the package also comprises a covering layer superimposed on the first supporting structure and on the second supporting structure and having a plurality of through openings, each superimposed on a respective cavity of said supporting structures.

### TECHNICAL FIELD

The present invention relates to a package for the containment and the display of articles, such as e.g. a modular package for the containment of alcoholic, perfumery or cosmetic articles, and to the related manufacturing process.

### BACKGROUND ART

Packages for perfumery or cosmetic articles are known, e.g., from EP3461755, on behalf of the same Applicant. Such packages generally have a supporting structure insertable within a box-shaped body wherein one or more seats are formed for housing a respective number of articles or products to be displayed according to a preferably vertical position. There is also the presence of a supporting layer, with through openings aligned with each of the seats, which is joined to the supporting structure with aesthetic functions or for the purpose of promoting and improving the retention, by interference, of the articles.

The construction of all, or most, parts of the package is done by thermoforming using moulds that must be designed in advance according to the specific customers' requirements. For example, when it is necessary for a first package to be made to contain two or three articles, usually of different features, the mould is constructed ad hoc by providing a first and a second counter-profile specifically for that first package. In the event that a second package being required to house a single fragrance, the housing of which is, however, identical to the first or second housing of the first package, it is still necessary to design a new mould with an individual counter-profile. The design of a mould is substantially always constrained to one and only one package: once a mould has been designed for a particular package, that mould cannot be used to make other packages except with identical characteristics.

### DESCRIPTION OF THE INVENTION

In the light of the problems outlined above, the main aim of the present invention is to enable the assembly of several supporting structures together so that modular packages can be made easily, thus greatly reducing production costs and at the same time reducing lead times as well as allowing for the reuse of moulds for making several different packages intended to house a plurality of articles on respective seats wherein at least one seat among those packages is identical.

This purpose is achieved by a package for the containment and the display of articles in accordance with claim 1.

According to a further aspect, the present invention relates to a manufacturing process of a package for the containment and the display of articles in accordance with claim 9.

According to yet another aspect, the present invention relates to a manufacturing process of a plurality of packages for the containment and the display of articles in accordance with claim 10.

### BRIEF DESCRIPTION OF THE DRAWINGS

Other characteristics and advantages of the present invention will become more apparent from the following description of a preferred, but not exclusive, embodiment of a package and the related manufacturing process illustrated by way of an indicative, yet non-limiting example, in the accompanying tables of drawings in which:

FIG. 1 is an exploded view of the constituent parts of the package according to the invention before assembly;

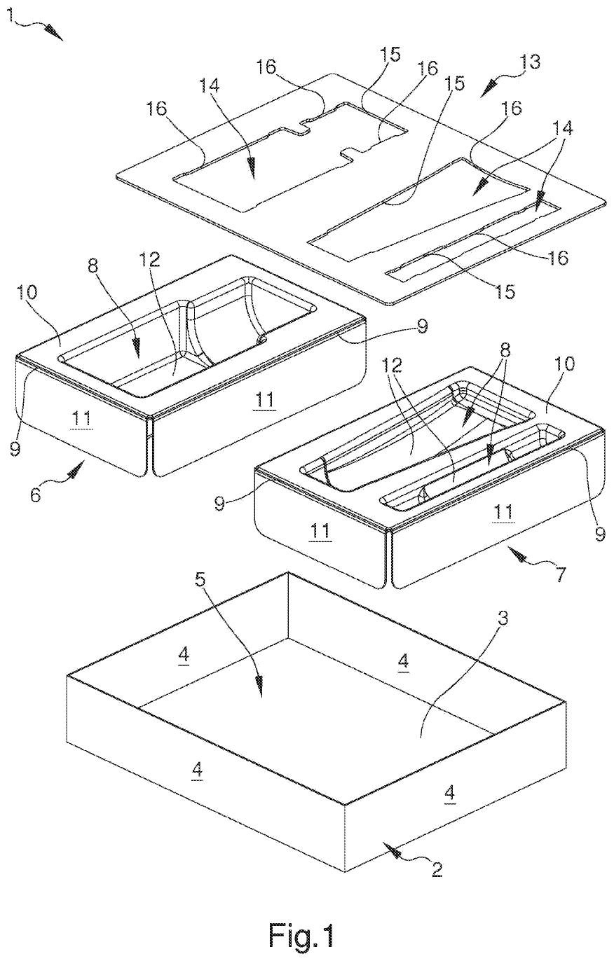

FIG. 2 is an exploded view of the package in FIG. 1 in which the supporting structures are side by side;

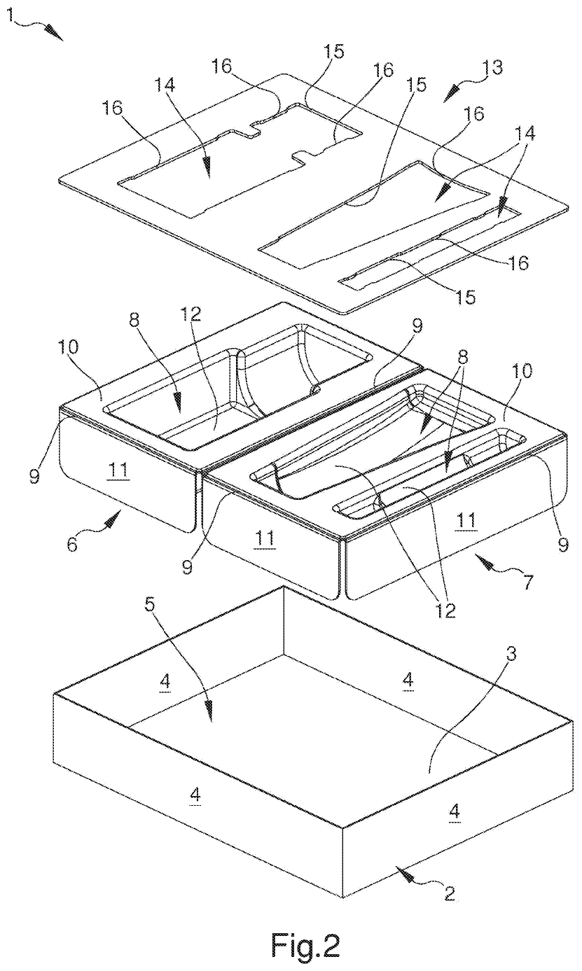

FIG. 3 is a perspective view of the assembled package in FIG. 1.

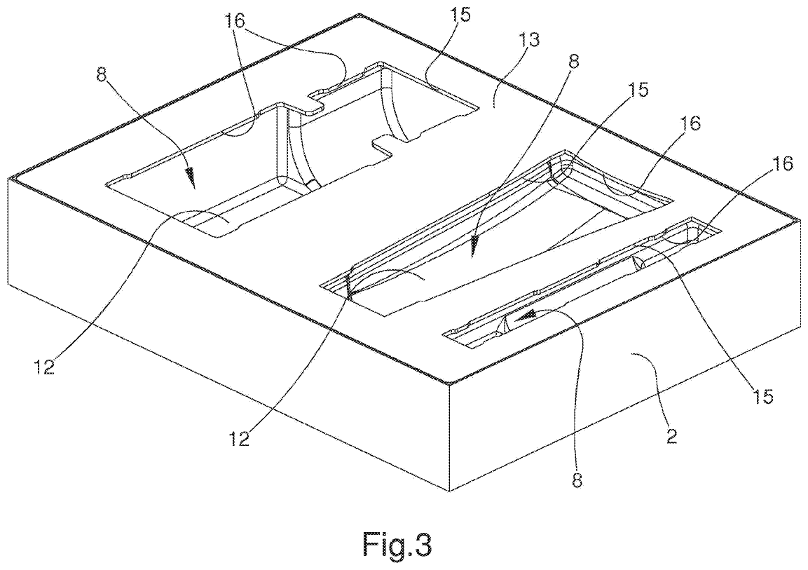

### EMBODIMENTS OF THE INVENTION

With particular reference to these figures, reference numeral 1 globally indicates a package for the containment and the display of perfumery or cosmetic articles according to the present invention.

The package 1 comprises a box-shaped body 2 provided with a bottom 3 and, preferably, with four side walls 4 that protrude transversely from the bottom 3 for a predetermined length. The bottom 3 and the side walls 4 are adapted to bound a housing compartment 5, open on the opposite side with respect to the bottom 3, to receive at least two supporting structures 6 and 7 for the containment of a plurality of articles. It is apparent that the shape of the bottom 3 of the box-shaped body 2 as well as the number of side walls 4 are irrelevant to the present disclosure, without altering the scope of protection of the present invention.

The package 1 may also comprise a lid (not shown) intended to engage with the box-shaped body 2 to close the package 1. According to further embodiments, different types of lids can be provided, such as sliding or hinged at one or more points to the box-shaped body 2.

Each supporting structure 6, 7 comprises at least one housing cavity 8 that serves as a seat for the at least partial housing of an article.

In accordance with one embodiment, each supporting structure 6, 7 comprises folding lines 9 defining a central portion 10 from which lateral flaps 11 extend opposite each other. The folding of the lateral flaps 11 allows the setting to volume of the structures 6, 7 and the subsequent insertion into the box-shaped body 2 so that the central portion 10 is oriented parallel to the bottom 3 of the box-shaped body 2. Each supporting structure 6, 7 may comprise at least two lateral flaps 11 opposite two by two to the central portion 10. In the preferred embodiment illustrated, each of the supporting structures 6, 7 has two pairs of lateral flaps 11 opposite two by two to the central portion 10.

According to further embodiments (not shown), the supporting structures 6, 7 may provide for non-folding flaps 11 or may consist only of the central portion 10 without the presence of flaps. In the latter case, the housing cavity 8 may rest at least partly onto the bottom 3 of the box-shaped body.

Advantageously, each supporting structure 6, 7 is made in a single body piece and the at least one cavity 8 is positioned at the central portion 10 from which it protrudes seamlessly.

In accordance with the preferred embodiment shown in the figures, the package 1 comprises at least a first supporting structure 6 and at least a second supporting structure 7. In detail, the first supporting structure 6 has a single housing cavity 8 while the second supporting structure 7 has two housing cavities 8. For the purposes of the present invention, the number of cavities 8 of each supporting structure 6, 7 may be chosen as desired depending on the type and quantity of articles to be housed in the package 1. Likewise, the housing cavities 8 may have different shapes and sizes complementary to the shape and size of the article they are to house.

Preferably, each cavity 8 has its own bottom 12, having concavity facing, in use, upwards i.e., the outside of the package 1, where the article rests in order to protrude even beyond the central portion 10.

As illustrated in the examples in the figures, the first supporting structure 6 and the second supporting structure 7 are housed within a single box-shaped body 2 in a side-by-side configuration so that their respective central portions 10 are also side by side and lie substantially on the same plane.

According to one embodiment, the respective central portions 10 of the supporting structures 6, 7, when side by side, may lie on different parallel planes.

Advantageously, the package 1 comprises a covering layer 13 superimposed on both supporting structures 6, 7 with an aesthetic function or to promote and improve the retention, by interference, of the articles. Advantageously, the covering layer 13 has a plurality of through openings 14 each superimposed on a respective cavity 8 of the supporting structures 6, 7. The through openings 14 are equal in number to the total number of cavities 8.

Preferably, each through opening 14 of the covering layer 13 is vertically aligned with the underlying housing cavity 8 and has substantially the same outline as the latter. In the examples shown, the covering layer 13 has three through openings 14 vertically aligned with three underlying housing cavities 8. The layer 13 comprises respective edges 15 that bound or contribute to bound the through openings 14. Typically, each edge 15 entirely surrounds a respective opening 14.

Advantageously, at least one stretch 16 of the edge 15 partly obstructs the entry of a respective article into the respective cavity 8.

Specifically, the stretch 16 defines retaining means for retaining, at least partly, a respective article the function of which is substantially the same as that described in patent EP3461755 under the name of the same Applicant and the description of which is incorporated herein by reference.

Advantageously, the box-shaped body 2, the supporting structures 6, 7 and/or the covering layer 13 can be made of solid, hygroscopic, biodegradable, bio-based, fiber materials (e.g., natural fiber or plant fiber), or combinations thereof. Preferably, the box-shaped body 2, the supporting structures 6, 7 and/or the covering layer 13 are made of a solid material comprising a paper and/or cardboard mixture.

The particular structural configuration of the package according to the invention is extremely advantageous in that it allows for enormous economical and timing benefits in the manufacturing process as well as in assembling the same. In detail, the manufacturing process of the package covered by the invention will be described below wherein two supporting structures 6, 7 are assembled.

Obviously, the scope of protection of the present invention will not be altered in the event of the number of supporting structures being greater.

In detail, a first phase involves having a box-shaped body 2 and transferring it from a pick-up station by means of a conveyor belt (or similar means of transfer) to an assembly station.

Next, there is a phase of having at least a first supporting structure 6 and at least a second supporting structure 7. The supporting structures 6, 7 are picked up from a feeding station by means of a pick-up device that, according to known techniques, sets the structures 6, 7 to volume by folding their respective flaps 11 along the folding lines 9.

As anticipated above, each supporting structure is made in advance through the use of a mould having counter-profiles substantially identical to the article or articles that the respective cavity of the structure is to accommodate. In the event that the same article being intended to be housed, together with other articles, in more than one package produced for different batches, it is advantageously possible to use the same mould for the formation of a plurality of identical supporting structures to be fitted in packages that are altogether different but have at least one identical housing cavity. Several supporting structures can substantially be combined within the same box-shaped body to form a potentially infinite amount of partly different packages. In this context, it will obviously be possible to combine more than two supporting structures with each other to be fitted, side by side, into the box-shaped body.

The process then provides for the structures 6, 7 to be fitted inside the housing compartment 5 of the box-shaped body 2 in a mutual side-by-side configuration. Once the structures 6, 7 are fitted into the box-shaped body 2, the latter is transferred to a bonding station at which one or more injectors apply a predetermined amount of glue, or similar adhesive substances, onto the central portions 10 of the two supporting structures 6, 7. Preferably, the adhesive substances are applied outside the housing cavities 8.

Next, the box-shaped body 2 is transferred to a joining station wherein a dedicated gripping device picks up a corresponding covering layer 13 from a respective feeding station to make it adhere onto the central portions 10 of the structures 6, 7 now provided with glue. The covering layer 13 thus remains firmly attached to the two central portions 10 and the package 1 is ready to be filled with the items to be displayed.

The surprising advantage of the process according to the invention is even more evident in the case where there is a plurality of partly similar packages to be manufactured. Assuming we have a plurality of box-shaped bodies 2 and three moulds in which:
the first mould is configured for the manufacture of a plurality of first supporting structures 6 intended to house at least one first article,
the second mould is configured for the manufacture of a plurality of second supporting structures 7 intended to house at least one second article, and
the third mould is configured for the manufacture of a plurality of additional supporting structures (not shown) intended to house at least one third article, it is possible, for example, to manufacture:
a first package wherein a first structure 6 and a second structure 7 are fitted inside the housing compartment 5 of a first box-shaped body 2, and
a second package wherein a first structure 6 and a further supporting structure are fitted inside the housing compartment 5 of a second box-shaped body 2.

It follows that the first package is intended to house two articles different from each other i.e., at least one first article and at least one second article, while the second package, which is different from the first package, is also intended to house two articles different from each other but a supporting structure of the two is made with the same mould used to make an identical supporting structure as the first package. The first package may substantially house at least the first article (made with the first mould) and at least the second article (made with the second mould), while the second package will house at least the first article (also made with the first mould) and at least one further article (made with the third mould).

In accordance with a further embodiment, the first package may also be intended to house two articles that are the same i.e., at least one first article and at least one second article, while the second package, which is different from the first package, is also intended to house two articles but one supporting structure of the two is made with the same mould used to make an identical supporting structure as the first package. The first package may substantially house at least the first article and the second article (made with the first mould), while the second package will house at least the first article (also made with the first mould) and at least one further article (made with a second mould). Obviously, the greater the quantities of the supporting structures and the articles the packages must contain, the greater the possible combinations and uses of the same moulds.

As verified by the present description, it has been ascertained that the described invention achieves the intended objects, and in particular, the fact is emphasized that by means of the packaging covered by the invention it is possible to fit a variable number of supporting structures inside the box-shaped body. It has also been noted that the manufacturing process allows for the production of multiple packages through the reuse of the same moulds. For example, in the case of manufacturing two or more partly similar packages intended to house a plurality of articles wherein at least one and the same article is housed in both the first and the second package, the same supporting structure can be used to be combined with different supporting structures.

1.-10. (canceled)

11. A Package for containment and display of articles comprising:
a box-shaped body provided with a bottom and with side walls adapted to bound a housing compartment;
at least one first supporting structure comprising at least one housing cavity for housing a respective article;
at least one second supporting structure side by side to said first supporting structure and comprising at least one housing cavity for housing a further respective article;
wherein said at least one first and one second supporting structures are configured to be at least partly fitted inside said housing compartment,
and wherein said package also comprises a covering layer superimposed on said first supporting structure and on said second supporting structure and having a plurality of through openings, each superimposed on a respective housing cavity of said at least one first and one second supporting structures.

12. The package according to claim 11, wherein said box-shaped body, said at least one first and one second supporting structures and/or said covering layer are made of solid, hygroscopic, biodegradable, bio-based, fiber materials (e.g., natural fiber or plant fiber), or combinations thereof.

13. The package according to claim 11, wherein said box-shaped body, said at least one first and one second supporting structures and/or said covering layer are made of a solid material comprising a paper and/or cardboard mixture.

14. The package according to claim 11, wherein each housing cavity is sized in such a way that the respective article is at least partly retained by interference therein.

15. The package according to claim 11, wherein each through opening of said covering layer has substantially a same outline as an underlying respective housing cavity.

16. The package according to claim 11, wherein said covering layer has at least one edge bounding or contributing to bound each through opening and wherein at least a stretch of said edge is configured to at least partly obstruct entry of a respective article into said housing cavity and to define retaining means of said respective article.

17. The package according to claim 11, wherein each of said at least one first and one second supporting structures is made from a laminar structure which, by means of folding lines, defines a central portion from which lateral flaps extend opposite each other.

18. The package according to claim 17, wherein each of said at least one first and one second supporting structures is made in a single body piece and said at least one housing cavity is positioned at said central portion from which said housing cavity protrudes seamlessly.

19. A manufacturing process of a package for containment and display of articles, comprising the following phases:
having a box-shaped body provided with a bottom and with side walls adapted to bound a housing compartment,
having at least one first supporting structure comprising at least one respective housing cavity for the housing of a respective article,
having at least one second supporting structure comprising at least one respective housing cavity for the housing of a further respective article,
fitting said at least one first and one second structures inside said housing compartment of the box-shaped body in a side by side configuration,
applying a predetermined amount of adhesive substance onto central portions of said said at least one first and one second supporting structures,
having a single covering layer and joining said single covering layer to the central portions of said at least one first and one second structures by bonding.

20. A manufacturing process of a package for containment and display of articles, comprising the following phases:
having a plurality of box-shaped bodies each provided with a bottom and with side walls adapted to delimit a housing compartment,
having a first mold for the manufacture of a plurality of first supporting structures provided with at least one respective housing cavity for the housing of at least one first article,
having a second mold for the manufacture of a plurality of second supporting structures provided with at least one respective housing cavity for the housing of at least one second article,
having a third mold for the manufacture of a plurality of further supporting structures provided with at least one respective housing cavity for the housing of at least one third article,
fitting said first supporting structure and said second supporting structure inside the housing compartment of a first box-shaped body in a side by side configuration,
fitting said first supporting structure and said further supporting structure inside the housing compartment of a second box-shaped body in a side by side configuration.
